(19) United States
(12) Patent Application Publication
(10) Pub. No.: US 2007/0220133 A1
(43) Pub. Date: Sep. 20, 2007

(54) Method For Correcting Time Data In A Network Management Application Using A Snmp

(75) Inventor: Sang Dae Park, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Korea Limited, Kyongki-do (KR)

(21) Appl. No.: 10/586,086

(22) PCT Filed: Jan. 14, 2005
(86) PCT No.: PCT/KR05/00138

§ 371 Date: Jun. 4, 2007

(30) Foreign Application Priority Data
Jan. 15, 2004 (KR) 10-2004-0002979

(51) Int. Cl. G06F 15/173

(52) U.S. Cl. 709/224

(57) ABSTRACT

The present invention is directed to a method for correcting time data in a network management application. In a conventional Simple Network Management Protocol (SNMP) application, time errors occur due to a time tick or a time delay in the network. To resolve the above problem, the present invention suggests a method for correcting the time data, wherein the network management application waits for the most polling periods to save system resources, checks time data for the last polling period, and requests performance information and statistic information. With the present invention, the possibility of incurring time errors due to the information request for polling can be resolved.

### TECHNICAL FIELD

The present invention is generally directed to a method of correcting time data when collecting performance data in a network management application using a Simple Network Management Protocol (SNMP), and more particularly to a method of enabling the application to collect more accurate performance data by correcting possible errors of the time data when collecting the performance data.

### BACKGROUND ART

The SNMP is a standard network management protocol for managing various kinds of Internet devices and was established as the first standard by International Engineering Task Force (IETF) in 1990. In an application using the SNMP, the application keeps statistical data from reply data, which is requested to statistic items periodically in order to collect statistical data. As a result of such information request, the reply data is stored along with the time data and can be used to evaluate the performance. However, the error of the time data can occur due to the delay of a network or a time tick of a device during the procedure of requesting periodical information.

### DISCLOSURE OF THE INVENTION

The primary objective of the present invention is to provide a method of correcting time data in a network management application so as to keep the performance information in a more precise manner.

The present invention provides a method for achieving the above objective, which comprises the following steps:

waiting for 90% of a polling period after requesting performance information and statistic information;

checking time data every 500 ms after the 90% of the polling period; and

requesting the performance information and the statistic information when information requesting time is reached.

### BRIEF DESCRIPTION OF THE DRAWINGS

FIG. 1 is a diagram illustrating time data in a network management application using a SNMP in accordance with the prior art; and

FIG. 2 is a diagram illustrating time data in a network management application using a SNMP in accordance with the present invention.

### BEST MODES FOR CARRYING OUT THE INVENTION

In view of the provided figures, a preferred embodiment of the present invention, which is in accordance with the subject matter disclosed above, will be described in detail.

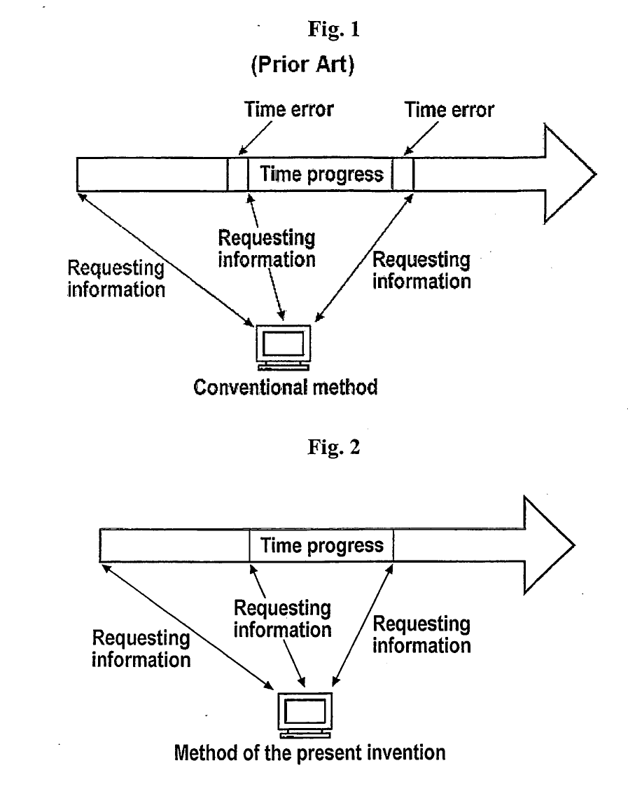

FIG. 1 shows a network management application using a conventional SNMP, in which the error of the time data is accumulated when requesting information periodically in order to collect performance information or statistical information. That is, since the method for collecting the information using the conventional SNMP is based on polling, the error of the time data would increase in proportion to the number of agents and the amount of data to be collected due to the execution time of data and the delay in the network. Moreover, if such error of the time data cannot be corrected appropriately, the error becomes accumulated and the application would inevitably fail.

FIG. 2 is a schematic view illustrating an implement of the network management application using the SNMP in accordance with the present invention. Different from the conventional method of correcting the time data which requests the information periodically after each predetermined interval of time, the method of the present invention requests the information at every exact time by continually checking the application's time tick.

The above method of collecting the performance information and the statistic information is described below. The method comprises the following steps:

waiting for 90% of a polling period after requesting performance information and statistic information;

checking time data every 500 ms after the 90% of the polling period; and

requesting the performance information and the statistic information when reaching information requesting time.

With the above method, the error of the time data decreases remarkably compared to when using the conventional method. In the conventional method, the time data of Nₜₕ, information requesting time can be obtained as follows.
D=(T+D1+D2)*N Equation 1

D: time data of Nₜₕ information requesting time

T: polling period

D1: time tick delay of device

D2: time delay of network

N number of requesting information

The value of (D1+D2)*N (i.e., D−T*N) is the error of time data and the error increases as N increases. However, the time data of Nₜₕ information requesting time according to the method of the present invention can be obtained as follows.
D=T*N+D1+D2 Equation 2

D: time data of Nₜₕ information requesting time

T: polling period

D1: time tick delay of device

D2: time delay of network

N: number of requesting information

In the above equation, the value of D−T*N equals to that of D1+D2, and the value is constant regardless of N. Therefore, if D1 and D2 are predictable, it is possible to keep the time data precise to some extent. Moreover, unless the values of D1 and D2 are accumulated, the variations of D1 and D2 would not affect the time data since the amount of an instantaneous error, such as a casual network delay or a time tick delay of a device, is so small that it can be neglected. In other words, when comparing equation 1 and equation 2, it will be appreciated that although the error of the time data increases in proportion to N with equation 1, the time data can be precisely kept in equation 2. This is because the error is affected only by the determined values, which is independent of N.

Therefore, the method of correcting the time data in a network management application using a SNMP in accordance with the present invention enables to keep the time data exact and to change the period of requesting information based on the above exact time data.

### INDUSTRIAL APPLICABILITY

The method of correcting time data in a network management application using a SNMP in accordance with the present invention provides the benefits in that the increase of delay time can be resolved. That is, although there exists a possibility that the management application cannot work due to the increasing delay time, which is originated from the polling scheme in the conventional application using a SNMP, the method of the present invention removes the above possibility by continuously monitoring the time of requesting information.

1. In a network management application using a Simple Network Management Protocol (SNMP), a method for correcting time data comprising the steps of:
waiting for 90% of a polling period after requesting performance information and statistic information;
checking time data every 500 ms after an elapse of the 90% of the polling period; and
requesting the performance information and statistic information when reaching information requesting time.
